(19) United States
(12) Patent Application Publication
(10) Pub. No.: US 2006/0125897 A1
(43) Pub. Date: Jun. 15, 2006

(54) Ink-jet printer

(75) Inventors: Kyung-chool Choi, Suwon-si (KR); Young-bok Ju, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/218,438

(22) Filed: Sep. 6, 2005

(30) Foreign Application Priority Data
Dec. 15, 2004 (KR) 10-2004-0106520

(51) Int. Cl. B41J 2/01

(52) U.S. Cl. 347/102

(57) ABSTRACT

An ink-jet printer includes a printing head having a nozzle unit for discharging ink onto recording media. A first drying unit primarily dries ink discharged by the nozzle unit. A second drying unit is set at a temperature higher than that of the first drying unit to secondarily dry the ink discharged by the nozzle unit.

### CROSS-REFERENCE TO RELATED PATENT APPLICATIONS

This application claims the benefit under 35 U.S.C. § 119(a) of Korean Patent Application No. 10-2004-0106520, filed on Dec. 15, 2004, in the Korean Intellectual Property Office, the entire disclosure of which is hereby incorporated by reference.

### BACKGROUND OF THE INVENTION

1. Field of the Invention

The present invention relates to an ink-jet printer. More particularly, the present invention relates to an ink-jet printer including a drying apparatus that dries images transferred on a recording medium.

2. Description of the Related Art

Generally, an ink-jet printer is an apparatus for forming desired images by injecting ink onto a recording medium from a printing head that is separated from an upper surface of the recording medium and that reciprocates perpendicularly to a conveying direction of the recording medium.

The recording medium, on which the image is formed while passing through the printing head, is discharged out of the apparatus and stacked. Another recording medium passes through the printing head to have an image formed thereon, is discharged out of the apparatus, and is stacked on the previously discharged recording medium. Therefore, the image recorded on the previously discharged recording medium contacts the back surface of the subsequently discharged recording medium.

Thus, when the image of the previously discharged recording medium is not dried, the image becomes distorted when it contacts the subsequently discharged recording medium.

Additionally, when it takes a long time to dry ink discharged onto the recording medium, such as in the event of high humidity, the ink is absorbed by the medium and causes the surface of the recording medium to become rough. Thus, to prevent the above phenomenon from occurring, the ink should be dried quickly after discharging the ink onto the recording medium before the ink is absorbed by the recording medium.

Additionally, a printing head has a nozzle portion with a length corresponding to a width of the recording medium (hereinafter, referred to as an array printing head) and has been used instead of the printing head reciprocating in the width direction of the recording medium to realize the printing operation at high speed.

In the ink-jet printer including the array printing head, the printing head is fixed and the recording medium is conveyed, and thus, a driving device of the printer can have a simple structure and the printing operation at a high speed can be performed.

Therefore, in the ink-jet printer including the array printing head, a device that dries ink on the recording medium faster than the conventional device in the ink-jet printer including the reciprocating printing head is required.

Accordingly, a need exists for an improved ink-jet printer having an array printing head that quickly dries ink applied to a printing medium to substantially prevent ink from being absorbed by the recording medium.

### SUMMARY OF THE INVENTION

Embodiments of the present invention provide an ink-jet printer including a drying device that dries ink within a short time in an array printing head that performs the printing operation at high speed, thereby substantially preventing ink from being absorbed by a recording medium and substantially preventing crumpling of the recording medium.

According to an aspect of the present invention, an ink-jet printer includes a printing head having a nozzle unit to discharge ink onto recording media. A first drying unit primarily dries ink discharged by the nozzle unit. A second drying unit has a temperature set higher than that of the first drying unit, and secondarily dries the ink discharged by the nozzle unit.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is a schematic side elevational view of an ink-jet printer including a drying device according to an exemplary embodiment of the present invention;

FIG. 2 is a bottom plan view of the drying device disposed in a printing head of FIG. 1;

FIG. 3 is a schematic side elevational view of an ink-jet printer including a drying device according to another exemplary embodiment of the present invention;

FIG. 4 is a bottom plan view of the drying device disposed in a printing head of FIG. 3;

FIG. 5 is a schematic side elevational view of an ink-jet printer including a drying device according to still another exemplary embodiment of the present invention;

FIG. 6 is a graph of temperature according to a conveying direction of recording media in the printing head including the drying device of FIG. 1; and

FIG. 7 is a flow chart illustrating the operation of drying ink with the drying device according to an exemplary embodiment of the present invention.

Throughout the drawings, like reference numerals will be understood to refer to like parts, components and structures.

### DETAILED DESCRIPTION OF EXEMPLARY EMBODIMENTS

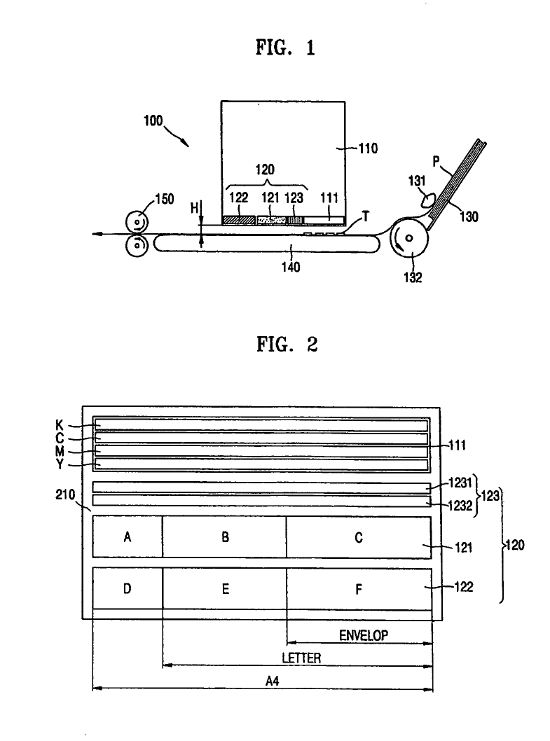

Referring to FIGS. 1 and 2, an ink-jet printer 100 includes a printing head 110 having a nozzle unit 111 with a length substantially corresponding to a width of a recording medium (P). A drying device 120 is disposed at a lower portion of the printing head 110 adjacent the nozzle unit 111 to dry an image (T) formed by ink discharged by the nozzle unit 111 onto the recording medium (P). A base frame 140 is disposed under the printing head 110 and separated from the printing head 110 by a head gap (H) to support the conveyed recording medium (P).

The recording media (P) stored on a feeding tray 130 is picked by a pickup roller 131 disposed in the ink-jet printer 100 proximal the media (P) and conveyed to the nozzle unit 111 by roller 132. The image (T) is formed on the recording media (P) by ink discharged from the nozzle unit 111 while passing through the base frame 140 The ink is dried while passing through the drying device 120. Then, the recording media (P) is discharged out of the ink-jet printer by a paper discharging unit 150.

Nozzle plates of yellow (Y), magenta (M), cyan (C), and black (K) colors are disposed under the nozzle unit 111 for forming full-color images.

The feeding tray 130 is shown in FIG. 1, however, a cassette (not shown) including a plurality of recording media (P) is disposed under the base frame 140. The recording media (P) are picked up from the cassette by a pickup roller (not shown) to be moved to the upper portion of the base frame 140.

The drying device 120 includes a first drying unit 121 and a second drying unit 122, and irradiates heat directly onto the image (T) transferred on the recording media (P). The first drying unit 121 is closer to the nozzle unit 111 than the second drying unit 122.

Preferably, the temperature of the drying device 120 increases sequentially in the conveying direction of the recording media (P), that is, toward the paper discharging unit 150. The second drying unit 122 is a heating material or substance generating heat at a higher temperature than the first drying unit 121. The second drying unit 122 may be any kind of heating material or substance.

The first drying unit 121 does not need to be a heating material or substance, but may be a heated material or substance that reaches a predetermined temperature by receiving heat from the second drying unit 122. Therefore, the heat generated by the second drying unit 122 is transmitted to the first drying unit 121 through the air.

As described, the temperature of the first drying unit 121 is set to be lower than that of the second drying unit 122, since the first drying unit 121 is adjacent to the nozzle unit 111. The ink may be hardened due to the temperature of the nozzle unit 111 when the temperature of the nozzle unit 111 is increased by the temperature of the second drying unit 122.

The drying device 120 may further include a separation unit 123 between the nozzle unit 111 and the first drying unit 121.

To substantially prevent ink from being hardened due to the temperature of the nozzle unit 111, the separation unit 123 is installed between the first drying unit 121 and the nozzle unit 111 to substantially prevent heat of the first drying unit 121 from being excessively transmitted to the nozzle unit 111.

The separation unit 123 includes a thermal control unit 1231 and a shielding unit 1232. The thermal control unit 1231 is preferably closer to the nozzle unit 111 than the shielding unit 1232.

The thermal control unit 1231 is formed to use the Peltier effect, such that when a weak electric current is applied to a contact surface of two different metals, heat is generated or absorbed at the contacting point. Therefore, the thermal control unit 1231 absorbs the heat when the temperature of the nozzle unit 111 is high, and emits heat in a case when the temperature of the nozzle unit 111 is low, thereby maintaining the nozzle unit 111 at substantially constant temperature.

The shielding unit 1232 prevents heat generated by the first drying unit 1231 from being transmitted to the nozzle unit 111. Preferably, the shielding unit 1232 is formed of a material that does not have thermal conductivity.

The first and second drying units 121 and 122 are divided into a plurality of sections substantially corresponding to the size of recording medium (P). That is, the first drying unit 121 is divided into sections A, B, and C, and the second drying unit 122 is divided into sections D, E, and F. The first and second drying units 121 and 122 operate differently for widths of various kinds of recording media (P) to prevent heat loss, thereby improving thermal efficiency.

For example, when the recording medium (P) is A4 sized, the entire first and second drying units 121 and 122 operate, and when the recording medium (P) is letter sized, sections B and C of the first drying unit 121 and sections E and F of the second drying unit 122 operate. Additionally, when the recording medium (P) is envelope sized, section C of the first drying unit 121 and section F of the second drying unit 122 operate.

The nozzle unit 111, the first drying unit 121, the second drying unit 122, and the separation unit 123 may be located at any portion under the printing head 110 if the head gap (H) between the printing head 110 and the recording medium (P) is maintained optimally for discharging ink. Therefore, the nozzle unit 111, the first drying unit 121, the second drying unit 122, and the separation unit 123 may be contained within the printing head 110 with respect to the lower surface of the printing head 110, or may protrude from the lower surface of the printing head 110.

FIG. 6 is a graph of temperature distribution according to the conveying direction of the recording medium in the printing head including the drying device of FIG. 1.

Referring to FIGS. 1 and 6, the temperature of the first drying unit 121 is lower than that of the second drying unit 122, and higher than that of the nozzle unit 111. Therefore, the temperature of the shielding unit 1232 is lower than that of the first drying unit 121 to substantially prevent the heat of the first drying unit 121 from being transmitted to the nozzle unit 111.

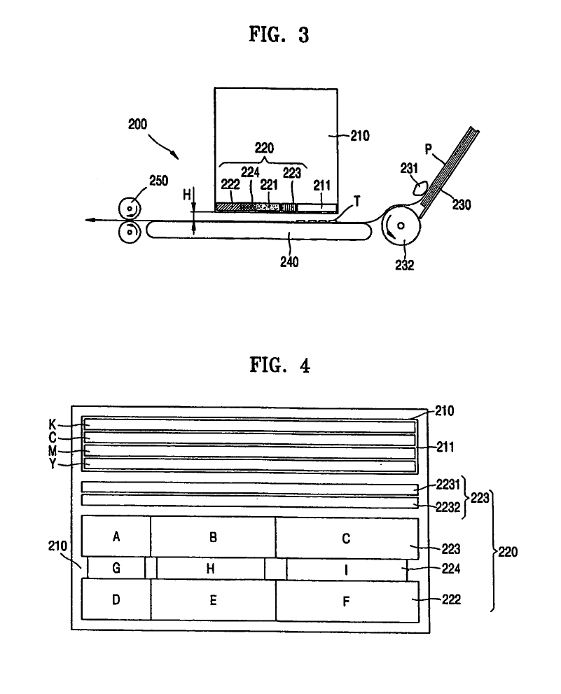

FIG. 3 is a side elevational view of an ink-jet printer including a drying device according to another exemplary embodiment of the present invention, and FIG. 4 is a bottom plan view of the drying device formed on the printing head shown in FIG. 3.

Referring to FIGS. 3 and 4, an ink-jet printer 200 includes a printing head 210 having a nozzle unit 211 with a width substantially corresponding to the width of the recording media (P). A drying device 220 is disposed under the printing head 210 adjacent to the nozzle unit 211 to dry the image (T) formed by ink discharged onto the recording media (P) from the nozzle unit 211. A base frame 240 is separated from the lower portion of the printing head 210 by a head gap (H) to support the conveyed recording medium (P).

The recording medium (P) loaded in a feeding tray 230 is picked by a pickup roller 231 disposed in the ink-jet printer 200 proximal the upper portion of the recording medium (P) and conveyed to the nozzle unit 211 by roller 232. The image (T) is formed on the recording media (P) by ink discharged from the nozzle unit 211 while passing through the base frame 240, and is dried while passing through the drying device 220. Then, the recording media (P) is discharged out of the ink-jet printer by a paper discharging unit 250.

Nozzle plates of yellow (Y), magenta (M), cyan (C), and black (K) colors are disposed under the nozzle unit 211 for forming full-color images.

The drying device 220 includes a first drying unit 221, a second drying unit 222, and a transmission unit 224, and irradiates heat directly onto the image (T) transferred on the recording media (P). The first drying unit 221 is closer to the nozzle unit 211 than the second drying unit 222.

Preferably, the temperature of the drying device 220 increases sequentially in the conveying direction of the recording media (P). That is, the second drying unit 222 is a heating material or substance generating heat of higher temperature than the first drying unit 221. The second drying unit 222 may be any kind of heating material or substance.

The first drying unit 221 does not need to be a heating material or substance, but mat be a heated material or substance that reaches a predetermined temperature by receiving heat from the second drying unit 222. The transmission unit 224 is installed to contact to both the first and second drying units 221 and 222 and to transmit heat generated by the second drying unit 222 to the first drying unit 221.

As described above, the temperature of the first drying unit 221 is set to be lower than that of the second drying unit 222. Because the first drying unit 221 is adjacent to the nozzle unit 211, the ink may be hardened due to the temperature of the nozzle unit 211 when the temperature of nozzle unit 211 is increased by the temperature of the second drying unit 222.

The drying device 220 may further include a separation unit 223 between the nozzle unit 211 and the first drying unit 221.

To substantially prevent the ink from being hardened due to the temperature of the nozzle unit 211, the separation unit 223 is installed between the first drying unit 221 and the nozzle unit 211 to substantially prevent the heat of the first drying unit 221 from being excessively transmitted to the nozzle unit 211.

The separation unit 223 includes a thermal control unit 2231 and a shielding unit 2232, as shown in FIG. 4. The thermal control unit 2231 is preferably closer to the nozzle unit 211 than the shielding unit 2232.

The thermal control unit 2231 is formed to use Peltier effect, such that when a weak electric current is applied to a contact surface of two different metals, heat is generated or absorbed at the contacting point. Therefore, the thermal control unit 2231 absorbs heat when the temperature of the nozzle unit 211 is high, and emits heat when the temperature of the nozzle unit 211 is low, thereby maintaining the nozzle unit 211 at a substantially constant temperature.

The shielding unit 2232 substantially prevents heat generated by the first drying unit 2231 from being transmitting to the nozzle unit 211. Preferably, the shielding unit 2232 is formed of a material that does not have thermal conductivity.

The first and second drying units 221 and 222 are divided into a plurality of sections substantially corresponding to the size of recording medium (P). That is, the first drying unit 221 is divided into sections A, B, and C, and the second drying unit 222 is divided into sections D, E, and F. The first and second drying units 221 and 222 operate differently for widths of various kinds of recording media (P) to substantially prevent heat loss, thereby improving thermal efficiency. The transmission unit 224 is divided into sections G, H, and I. The sections of the transmission unit 224 are separated from each other to substantially prevent heat from being transmitted to other sections when the first drying unit 221 and the second drying unit 222 operate in different section units from each other according to the width of the recording media (P). Section G connects section A and section D, section H connects section B and section E, and section I connects section C and section F.

Therefore, when the recording medium (P) is A4 sized, the entire first and second drying units 221 and 222 operate. When the recording medium (P) is letter sized, sections B and C of the first drying unit 221 and sections E and F of the second drying unit 222 operate. When the recording medium (P) is envelope sized, section C of the first drying unit 221 and section F of the second drying unit 222 operate.

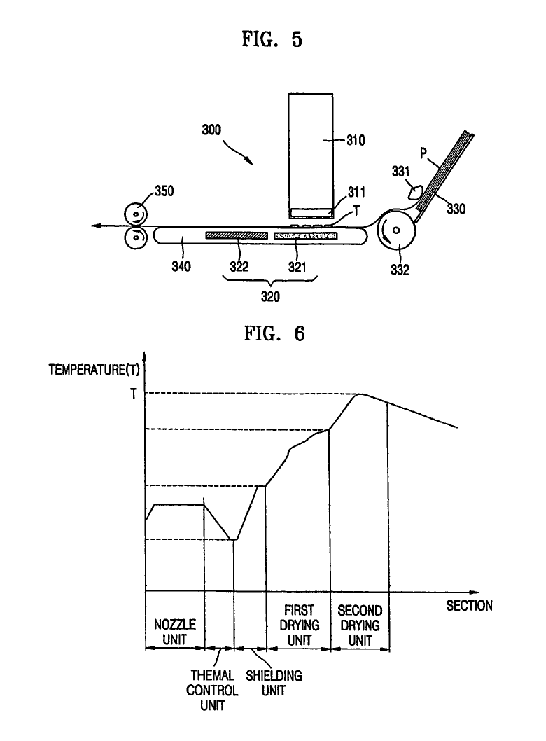

FIG. 5 is a side elevational view of an ink-jet printer including a drying device according to still another exemplary embodiment of the present invention.

Referring to FIG. 5, the ink-jet printer 300 includes a printing head 310 having a nozzle unit 311 with a length substantially corresponding to the width of the recording medium (P). A base frame 340 is disposed under the printing head 310 and separated from the printing head 310 by a head gap (H) to support the conveyed recording media (P). A drying device 320 is disposed in the base frame 340 to dry the image (T) formed on the recording medium (P) by ink discharged from the nozzle unit 311 onto the recording medium (P).

The recording medium (P) loaded in a feeding tray 330 is picked up by a pickup roller 331 disposed in the ink-jet printer 300 proximal the upper portion of the recording medium (P), and conveyed to the nozzle unit 311 by roller 332. The image (T) is formed on the recording media (P) by ink discharged from the nozzle unit 311 while passing through the base frame 340, and is dried while passing through the drying device 320. After that, the recording media (P) is discharged out of the ink-jet printer 300 by a paper discharging unit 350.

Nozzle plates of yellow (Y), magenta (M), cyan (C), and black (K) colors are disposed under the nozzle unit 311 for forming full-color images.

The feeding tray 330 is shown in FIG. 5, however, a cassette (not shown) including a plurality of recording media (P) is disposed under the base frame 340, and the recording media (P) are picked up by a pickup roller (not shown) to be moved to the upper portion of the base frame 340.

The drying device 320 includes a first drying unit 321 and a second drying unit 322, and irradiates heat toward the back surface of the recording medium (P) to dry the image (T) indirectly. Preferably, the drying device 320 is installed inside the base frame 340.

Preferably, the temperature of the drying device 320 increases sequentially in the conveying direction of the recording media (P). That is, the second drying unit 322 is a heating material or substance generating heat of higher temperature than the first drying unit 321. The second drying unit 322 may be any kind of heating material or substance.

The first drying unit 321 is installed to face the nozzle unit 311. Additionally, the first drying unit 321 does not need to be a heating material or substance, but may be a heated material or substance that reaches a predetermined temperature by receiving heat from the second drying unit 322.

As described above, the temperature of the first drying unit 321 is set to be lower than that of the second drying unit 322. Because the first drying unit 321 is adjacent to the nozzle unit 311, the ink may be hardened due to the temperature of the nozzle unit 311 when the temperature of nozzle unit 311 is increased by the temperature of the second drying unit 322.

Preferably, the first drying unit 321 and the second drying unit 322 are divided into plural sections so that each section may operate independently.

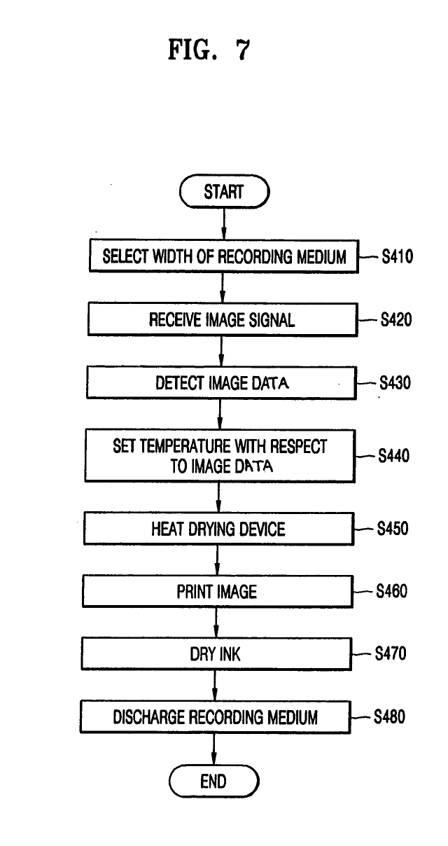

FIG. 7 is a flow chart illustrating a process of drying ink with a drying device according to an exemplary embodiment of the present invention.

Referring to FIGS. 1 and 7, the size of the recording medium (P) on which images are formed, for example, the width of the recording medium (P), is selected (S410). A user may directly select the size of the recording medium (P), or the size of the recording medium (P) may be automatically selected by detecting the conveyed recording medium (P).

An image data signal is received to forming an image (S420).

A controller (not shown) detects image data formed on the recording medium (P) using the received image data signal (S430). In operation S430, the image duty may be detected or the conveying speed of the recording medium (P) may be detected corresponding to the image data signal.

The controller (not shown) sets an appropriate temperature for drying the printed image corresponding to the image data detected in operation S420 (S440). Temperatures with respect to the image data corresponding to the image data signal are set in advance and stored, and the temperatures of the first and second drying units 121 and 122 for drying the image with respect to the image data detected in operation S420 may be set. The temperature of the first drying unit 121 is preferably be set to be lower than the second drying unit 122.

The first and second drying units 121 and 122 are heated to set the temperatures of the first and second drying units 121 and 122 with respect to the image data corresponding to the image data signal (S450). Sections of the first and second drying units 121 and 122 are set corresponding to the width of the recording medium selected in S410, and only the selected sections are heated.

Additionally, although the heating sections of the first and second drying units 121 and 122 are set, the temperature may be differentially applied in the same heating section corresponding to the data rate of the image. For example, the temperature of the first and second drying units 121 and 122 is increased at the portion where a lot of images are formed, and the temperature becomes lower at the portion where the image is less formed.

The desired image is formed on the recording medium (P) through the nozzle unit 111 (S460). The first and second drying units 121 and 122 heat the recording medium (P) on which the image is formed to dry the image (S470).

The recording medium (P) on which the image is dried in operation S470 is discharged out of the printer (S480).

As described above, in the ink-jet printer of exemplary embodiments of the present invention, temperatures of the drying section and a plurality of drying units are set corresponding to the images. Thus, the ink may be dried in a short time and ink blots generated when the recording media overlap each other may be substantially prevented.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An ink-jet printer, comprising:
a printing head having a nozzle unit for discharging ink onto recording media;
a first drying unit adapted to dry the ink discharged by the nozzle unit; and
a second drying unit having a temperature set higher than that of the first drying unit to further dry the ink discharged by the nozzle unit.

2. The ink-jet printer of claim 1, wherein
the first drying unit and the second drying unit are installed under the printing head adjacent to the nozzle unit, and irradiate heat directly onto the image while increasing the temperature in the conveying direction of the recording media.

3. The ink-jet printer of claim 1, wherein
the second drying unit generates heat at a temperature higher than that of the first drying unit.

4. The ink-jet printer of claim 1, wherein
a transmission unit is disposed between the first drying unit and the second drying unit to transmit the heat generated by the second drying unit to the first drying unit.

5. The ink-jet printer of claim 4, wherein
the first drying unit is a heated material.

6. The ink-jet printer of claim 1, wherein
a separation unit is disposed between the nozzle unit and the first drying unit to substantially prevent heat from being transmitted to the nozzle unit from the first drying unit.

7. The ink-jet printer of claim 6, wherein
the separation unit includes a thermal control unit absorbing or generating heat selectively, and a shielding unit for shielding the heat transmission between the drying unit and the nozzle unit.

8. The ink-jet printer of claim 7, wherein
the thermal control unit is installed adjacent the nozzle unit.

9. The ink-jet printer of claim 1, wherein
the first drying unit and the second drying unit are respectively divided into a plurality of sections so that the drying units operate the plurality of sections substantially corresponding to a width of the recording media.

10. The ink-jet printer of claim 1, wherein
the first and second drying units are installed in a base frame installed under the printing head, and irradiate heat onto the image formed on the recording media while increasing the temperature gradually in parallel to the conveying direction of the recording media.

11. The ink-jet printer of claim 10, wherein
the first drying unit faces the nozzle unit, and the second drying unit is a heating material that is installed adjacent the first drying unit and generates heat at a temperature higher than the first drying unit.

12. The ink-jet printer of claim 10, wherein
the first and second drying units are formed inside the base frame.

13. The ink-jet printer of claim 11, wherein
the first and second drying units are respectively divided into a plurality of sections so that drying units operate the plurality of sections according to widths of the recording media.

14. A method of drying ink in an ink-jet printer, comprising the steps of
receiving an image signal;
detecting an image data of the received image signal;
setting temperatures of drying units corresponding to the image data of the image signal;
increasing the temperatures of the drying units; and
drying an image transferred onto a recording medium using the drying devices.

15. The method of claim 14, further comprising
detecting a size of the recording medium before receiving the image signal.

16. The method of claim 14, wherein
heating sections in the drying units are set corresponding to a size of the recording medium; and
operating the sections of the drying units corresponding to the size of the recording medium when increasing the temperature of the drying units.

17. The method of claim 14, wherein
drying the image on the recording medium comprises passing the recording medium by first and second drying units.

18. The method of claim 17, wherein
the temperature of the second drying unit is set higher than the temperature of the first drying unit.

19. The method of claim 18, wherein
the recording medium passes by the first drying unit before passing through the second drying unit.

20. The method of claim 18, further comprising
transferring heat from the second drying unit to the first drying unit to bring the first drying unit to a predetermined temperature.
